(19) United States
(12) Patent Application Publication
(10) Pub. No.: US 2026/0261320 A1
(43) Pub. Date: Sep. 3, 2026

(54) METHODS AND APPARATUSES FOR 8 TX NON-COHERENT RANK ADAPTIVE UL MIMO CODEBOOK

(71) Applicant: TELEFONAKTIEBOLAGET LM ERICSSON (PUBL), Stockholm (SE)

(72) Inventors: Stefan PARKVALL, BROMMA (SE); Robert Mark HARRISON, GRAPEVINE, TX (US)

(21) Appl. No.: 19/489,966

(22) PCT Filed: Jun. 6, 2024
(86) PCT No.: PCT/IB2024/055545

§ 371 Date: Dec. 4, 2025

Related U.S. Application Data
(60) Provisional application No. 63/506,808, filed on Jun. 7, 2023.
(60) Provisional application No. 63/507,042, filed on Jun. 8, 2023.

(51) Int. Cl. H04B 7/06; H04W 72/21

(52) U.S. Cl. CPC H04B 7/0639; H04W 72/21

(57) ABSTRACT

There is provided a method in a UE, for adapting a codebook based on the number of layers for transmissions. The method comprises: receiving a configuration of a codebook to use for uplink transmissions; mapping a list of indices to precoders of the codebook according to a rank of the precoders, wherein the list of indices are mapped to values of a parameter (“N”), first by increasing values of a number of transmitted layers and then by increasing values of N for a given number of layers; and transmitting a layer on an antenna port that corresponds to a value of the parameter N.

### RELATED APPLICATIONS

This application claims the benefits of priority of U.S. Provisional Patent Application No. 63/507,042, entitled “8 TX NON-COHERENT RAND ADAPTIVE UL CODEBOOK” and filed at the United States Patent and Trademark Office (USPTO) on Jun. 8, 2023, and of U.S. Provisional Patent Application No. 63/506,808, entitled “COMPACT AND FLEXIBLE 8 TX NON-COHERENT UL CODEBOOKS” and filed at the USPTO on Jun. 7, 2023, both of which are hereby incorporated by reference in its entirety.

### TECHNICAL FIELD

The present disclosure relates to wireless network communications using non-coherent rank adaptive UL codebooks.

### BACKGROUND

### UpLink (UL) Transmission/Precoding Schemes

The physical channel that carries data in the New Radio (NR) UL is called the Physical Uplink Share Channel (PUSCH). In NR, there are two possible waveforms that can be used for PUSCH: Cyclic Prefix Orthogonal Frequency Division Multiplexing (OFDM) (CP-OFDM) and Discrete Fourier Spread OFDM (DFT-S-OFDM). Also, there are two transmission schemes specified for PUSCH: Codebook (CB)-based precoding and Non-CB (NCB)-based precoding.

The gNode B (gNB) configures, in Radio Resource control (RRC), the transmission scheme through the higher-layer parameter txConfig in the PUSCH-Config Information Element (IE). CB-based transmission can be used for non-calibrated User Equipments (UEs) and/or for Frequency Division Duplexing (FDD) (i.e., UL/DonwLink (DL) reciprocity does not need to hold). NCB-based transmission, on the other hand, relies on UL/DL reciprocity and is, hence, intended for Time Division Duplexing (TDD).

### CB-Based Precoding

CB-based PUSCH is enabled if the higher-layer parameter txConfig is set to ‘codebook’. For dynamically scheduled PUSCH with configured grant type 2, CB-based PUSCH transmission can be summarized in the following steps:
1. The UE transmits Sounding Resource Signal (SRS), configured in an SRS resource set with higher-layer parameter usage in SRS-Config IE set to ‘codebook’. Up to two SRS resources (for testing up to two virtualizations/beams/panels) each with up to four ports, can be configured in the SRS resource set.
2. The gNB determines the number of layers (or rank) and a preferred precoder (i.e., Transmit Precoding Matrix Index (TPMI)) from a codebook subset based on the received SRS from one of the SRS resources. The codebook subset is configured via the higher-layer parameter codebookSubset, based on reported UE capability, and is one of:
   fully coherent (‘fully AndPartialAndNonCoherent’), or
   partially coherent (‘partialAndNonCoherent’), or
   non-coherent (‘nonCoherent’),
3. If two SRS resources are configured in the SRS resource set, the gNB indicates the selected SRS resource via a 1-bit SRS Resource Indicator (SRI) field in the Downlink Control Information (DCI) scheduling the PUSCH transmission. If only one SRS resource is configured in the SRS resource set, the SRI field is not indicated in DCI.
4. The gNB indicates, via DCI, the number of layers and the TPMI. Demodulation Reference Signal (DM-RS) port(s) associated with the layer(s) are also indicated in DCI. The number of bits in DCI used for indicating the number of layers (if transform precoding is enabled, the number of PUSCH layers is limited to 1) and the TPMI is determined as follows (unless UL full-power transmission is configured, for which the number of bits may be different):
   4, 5, or 6 bits if the number of antenna ports is 4, if transform precoding is disabled, and if the higher-layer parameter maxRank in PUSCH-Config IE is set to 2, 3, or 4 (see Table 1).
   2, 4, or 5 bits if the number of antenna ports is 4, if transform precoding is disabled or enabled, and if the higher-layer parameter maxRank in PUSCH-Config IE is set to 1 (see Table 2).
   2 or 4 bits if the number of antenna ports is 2, if transform precoding is disabled, and if the higher-layer parameter maxRank in PUSCH-Config IE is set to 2 (see Table 3).
   1 or 3 bits if the number of antenna ports is 2, if transform precoding is disabled or enabled, and if the higher-layer parameter maxRank in PUSCH-Config IE is set to 1 (see Table 4).
   0 bits if 1 antenna port is used for PUSCH transmission.
5. The UE performs PUSCH transmission over the antenna ports corresponding to the SRS ports in the indicated SRS resource.

3GPP TS 38.212 provides precoding information for different number of layers and different antenna parts. Fr example, Table 7.3.1.1.2-2 provides information for Precoding information and number of layers, for 4 antenna ports, if transform precoding is disabled and maxRank=2, 3 or, 4; Table 7.3.1.1.2-3 provides information Precoding information and number of layers, for 4 antenna ports, if transform precoding is disabled/enabled and maxRank=1; Table 7.3.1.1.2-4 provides information for Precoding information and number of layers, for 2 antenna ports, if transform precoding is disabled and maxRank=2 (reproduced from Table of 3GPP TS 38.212); and Table 7.3.1.1.2-5 provides information for Precoding information and number of layers, for 2 antenna ports, if transform precoding is disabled/enabled and maxRank=1.

For a given number of layers, the TPMI field indicates a precoding matrix that the UE should use for PUSCH. In a first example, if the number of antenna ports is 4, the number of layers is 1, and transform precoding is disabled, then the set of possible precoding matrices is shown in Table 2. In a second example, if the number of antenna ports is 4, the number of layers is 4, and transform precoding is disabled then the set of possible precoding matrices is shown in Table 3

TABLE 2
Precoding matrix, W, for single-layer transmission using four antenna ports
when transform precoding is disabled (reproduced from Table 6.3.1.5-3 of 3GPP TS
38.211).

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix, W, for four-layer transmission using four antenna ports
when transform precoding is disabled (reproduced from Table 6.3.1.5-7 of 3GPP TS
38.211).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

How fully-, partially-, and non-coherent coherent transmission is facilitated in Release (Rel)-15 codebook-based transmission can be understood through the example precoding matrices above. Each column of a matrix contains a set of scale factors to be used to transmit a Multiple Input Multiple Output (MIMO) layer, and each row of a given column contains the scale factor to be applied to a particular antenna port for that layer. If a given scale factor is zero, then the UE should not transmit the MIMO layer on the antenna port. On the other hand, if at least two scale factors in a column are non-zero, they will combine together for a given layer, and the UE must transmit with mutually controlled phase among these antenna ports. If each column of a precoding matrix contains only one non-zero scale factor, the UE may transmit non-coherently, i.e., without mutually controlled phase. Examples of such non-coherent precoding matrices are those with TPMI indices 0-3 in Table 2 and with TPMI index 0 in Table 3. By contrast, if each column of a precoding matrix contains only non-zero scale factors, the UE must transmit with mutually controlled phase on all antenna ports, and so uses fully coherent transmission. Examples of fully-coherent precoding matrices include TPMI indices 12-27 in Table 2 and TPMI indices 3 and 4 in Table 3. Finally, if each column of a precoding matrix contains some non-zero and some zero scale factors, the UE may transmit partially-coherently, with mutually controlled phase required only among subsets of the antenna ports. Examples of partial-coherent precoding matrices include TPMI indices 4-11 in Table 2 and TPMI indices 1 and 2 in Table 3. It is important to also observe here that partial-coherent precoding is not possible for 2 transmit (Tx) operation, since with two port transmission either all or none of the ports are transmitted together in a coherent way. This need to consider partial-coherent operation complicates the design of 4 Tx UL MIMO schemes.

UEs that can maintain phase among antenna ports can generally transmit also without controlled phase. The converse where UEs that can transmit without controlled phase can be assumed to be able to also transmit with controlled phase is generally not true. Since transmitting without controlled phase is enabled through the use of zero-valued scale factors in Rel-15 non-coherent or partially-coherent precoding matrices, these precoders may be used to select which antenna ports to transmit upon. When the antennas corresponding to the antenna ports are directive, such selection can pick directions that the UE should transmit, and so these precoders can have better performance in some channel conditions than the fully coherent precoders (provided sufficient power is available for the antennas). Furthermore, transmitting on a subset of antenna ports can allow the UE to transmit with reduced total power. These two behaviors then can motivate the codebook designs described above, where precoding matrices with different coherence requirements are included in a codebook. Fully coherent UEs can support all three types of precoders, and so can support codebook subsets labeled as ‘fully AndPartialAndNonCoherent’, while partially-coherent UEs can support non-coherent but not fully-coherent precoders, and so can support ‘partialAndNonCoherent’ codebook subsets. Lastly, non-coherent UEs only support the ‘nonCoherent’ precoders and codebook subset. This combination of precoders with different coherence types in a codebook or codebook subset may be referred to as ‘nesting’ the precoders.

The structure of non-coherent precoders in the Rel-15 design targets maximum performance. One precoder is defined for each possible combination of ports for a given number of layers with non-coherent operation. For example, in Table 4 below for two layer transmission with 4 ports, it can be seen that TPMI indices 0 to 5 include all 6 combinations for 2 out of 4 ports. Similarly, the 4 possible port combinations when one out of 4 ports are defined in TPMIs 0-3 for the single layer case as can be seen in Table 2 above. Moreover, it can be observed that each layer can be carried on 3 of the 4 antenna ports in the two layer case and all 4 of the antenna ports in the 1 layer case. This use of all possible combinations and occupancy of more than half of the antenna ports for non-coherent 1 and 2 layer transmission provides the best possible set of selections and therefore maximizes the performance of the non-coherent codebook by maximizing the diversity gain. By contrast, considering the 3 layer codebook with 4 ports in Table 5, there is a single non-coherent precoder defined: TPMI 0. In this case, fewer than all ports are transmitted on by the non-coherent precoder, since port 3 is not used. A rationale for using fewer than all port combinations for rank 3, but not ranks 2 or 1, is that there is less selection diversity gain with an increased number of ports or layers when non-coherent transmission is used.

TABLE 4
Precoding matrix W for two-layer transmission using four antenna ports with
transform precoding disabled (reproduced from Table 6.3.1.5-5 of 3GPP TS 38.211).

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for three-layer transmission using four antenna ports with
transform precoding disabled (reproduced from Table 6.3.1.5-6 of 3GPP TS 38.211).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Considering the partially coherent precoders in TPMI indices 6-13 in Table 4, it can be observed that, for all these precoders, the first layer (corresponding to the elements in the first column of each precoder) is transmitted on ports 0 and 2, while the second layer (the elements in the second column) is transmitted on ports 1 and 3. This design supports where only ports 0 and 2 or ports 1 and 3 are mutually coherent; if a layer were transmitted with ports 1 and 2 for example, then this would require coherence among ports 0, 1, and 2, which is not consistent with the notion of partial coherence where only pairs of Tx chains are coherent in a partially coherent UE. Examining Table 5 for 3 layer transmission, the same constraint applies. Partially coherent TPMIs 1 and 2 use ports 0 and 2 for the first layer, and ports 1 and 3 for the second and third layers, respectively.

Accordingly, as part of the agreements for codebook-based transmission for 8 Tx, it has been agreed that the UE can transmit with non-coherent precoders if there are no controlled phase between the 8 antenna ports. Further, two types of partially-coherent UEs will be supported, one with 2 antenna groups (with 4 antenna ports per antenna group), and one with four antenna groups (with two antennas ports per antenna group). It has also been agreed that the antennas within one antenna group are assumed to be mutually coherent, and antenna ports belonging to different antenna groups are assumed not to be mutually coherent. Though the non-coherent precoders is agreed for rank 1, the non-coherent precoders for rank >1 still need to be agreed.

A proposal for a non-coherent codebook with a reduced number of precoders was discussed in RAN1 #112bis-e in R1-2302309 as follows. The design assumes a uniform linear array of cross-polarized elements, wherein both polarizations of an element are used before using another element, and adjacent elements are used first.
Updated Proposal 3.5: For non-coherent uplink precoding with rank≤8 by an 8TX UE,
   Alt1.—All 255 combinations of non-coherent rank1 precoders are supported
   Alt2.—Only a subset of Alt1. is supported
      Example (ZTE, Samsung): For the shown antenna set up, NC precoders can be defined as follows,

During RAN1 #113, it was agreed to support an 8 Tx non-coherent codebook using Alt 1 of the updated proposal above, as described below:
Agreement
   For non-coherent uplink precoding by an 8TX UE, support Alt1.,
   Alt1.—All 255 combinations from 8 non-coherent rank1 precoders are supported

### SUMMARY

Systems and methods related to compact and flexible eight (8) transmit antenna port non-coherent codebook design and configuration and associated transmission are disclosed. For example, for non-coherent 8 Tx UL codebooks, the codebook according to a Rel-18 draft Change Request (CR) gives a sub-optimal TPMI to precoder/rank mapping in case UL rank restriction is used to reduce DCI overhead.

The disclosure describes a new mapping between TPMIs and precoder/rank for non-coherent UL codebooks that can fix this issue by making sure that the TPMI index is ordered according to the rank of the precoders.

According to one aspect, there is provided a method at a UE, for uplink communications. For example, the method comprises: receiving a configuration of a codebook to use for uplink transmissions; mapping a list of indices to precoders of the codebook according to a rank of the precoders, wherein the list of indices are mapped to values of a parameter (“N”), first by increasing values of a number of transmitted layers and then by increasing values of N for a given number of layers; and transmitting a layer on an antenna port that corresponds to a value of the parameter N. An UE, with processing circuitry and network interface, is also provided for performing this method.

According to another aspect, there is provided a method performed by a network node in communications with a UE. For example, the method comprises: sending a configuration of a codebook to the UE; mapping a list of indices to precoders of the codebook according to a rank of the precoders, wherein the list of indices are mapped to values of a parameter (“N”), first by increasing values of a number of transmitted layers and then by increasing values of N for a given number of layers; and transmitting an indication of an index from the list, corresponding to a precoder of the codebook, for the UE to use for uplink transmissions. A network node, with processing circuitry and network interface, is also provided for performing this method.

According to yet another aspect, there is provided a method in a UE, the method comprises: determining a codebook, wherein a precoding matrix W type A with 8 antenna groups for up to 8 layer transmission uses eight antenna ports, wherein up to 8 layers are supported with transform precoding disable and the precoding matrix W is given by

$$W = 1 / \sqrt{v} [ {e}_{{p}_{0}} … {e}_{{p}_{v - 1}} ]$$

where column i of W, eᵢ, is has an element 1 on the row corresponding to the port p; on which layer i is to be transmitted, and element 0 in all other rows, pᵢ<pᵢ₊₁,

$$N = {\sum }_{p = 0}^{7} δ ( p ) {2}^{p} ,$$

where δ(p)=1 if a layer is to be transmitted on port p and δ(p)=0 otherwise, and

$$Δ ( z ) = {\sum }_{k = 1}^{z} C ( 8 , k )$$

for x≥1, where C(x,y) is defined by Table 5.2.2.2.5-4 of 38.214. TPMI indices 0 to Δ(v)−1 are mapped to values of N, first by increasing values of the number of transmitted layers, and then by increasing values of N for a given number of layers.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a signal diagram for adapting a codebook between a UE and a gNB, according to an embodiment.

FIG. 2 is a flow chart that illustrates a method in a UE according to an embodiment.

FIG. 3 is a flow chart that illustrates a method in a network node according to an embodiment.

FIG. 4 shows an example of a communication system in accordance with some embodiments of the present disclosure.

FIG. 5 shows a UE in accordance with some embodiments of the present disclosure.

FIG. 6 shows a network node according to an embodiments of the present disclosure.

FIG. 7 is a block diagram illustrating a virtualization environment in which functions implemented by some embodiments of the present disclosure may be virtualized.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). For the 8 Tx codebook transmission, the Non-Coherent (NC) codebooks can be designed by selecting all the precoder matrices obtained by choosing r ports out of 8 ports, where r is the transmission rank. This will result in 255 candidates for the maximum rank of 8, requiring 8 bits of DCI signaling overhead. One possibility to do this is to base the codebook generation on the binary representation of the TPMI. In a draft CR submitted to RAN1 for discussion, this is expressed as:

| TPMI | |
|---|---|
| index | W |
| 1-255 | W = 1/\sqrt{8}[eₚ_{₀} ... eₚ_{ᵥ₋₁}] |
| | where column i of W, eᵢ, has an element 1 on the row corresponding to the |
| | port pᵢ on which layer i is to be transmitted, and element 0 in all other rows, |
| | pᵢ < pᵢ₊₁, |
| | $and TPMI index = {\sum }_{p = 0}^{7} δ ( p ) {2}^{p} , where δ ( p ) = 1 if a layer is to be$ |
| | transmitted on port p and δ(p) = 0 otherwise |

However, this results in precoders of different ranks not necessarily having adjacent TPMI indices which may complicate the overall design of control signaling. It is therefore desirable to find a method to generate codebooks such that precoders for the same rank have adjacent TPMI indices, sorted such that the lower TPMI indices correspond to lower rank precoders.

Certain aspects of the disclosure and their embodiments may provide solutions to these or other challenges. For 8 Tx codebook transmission, the maximum number of NC precoders is 255, which can consume 8 bits for DCI signaling overhead. However, 255 precoders are needed only for rank 8 transmission, and if the codebook is adapted according to lower ranks, fewer precoders, and reduced DCI overhead could be used. Therefore, a method of adapting the NC codebook according to the rank is needed.

Some embodiments can be summarized according to the following: (the following precoding matrix can be used for precoding).

Table 6 (or Table 6.3.1.5-8): Precoding matrix W type A with 8 antenna groups for up to 8 layer transmission using eight antenna ports. Up to 8 layers are supported with transform precoding disabled and up to one layer with transform precoding enabled.

| TPMI | |
|---|---|
| index | W |
| 0-Δ(v) − 1 | W = 1/\sqrt{v}[eₚ_{₀} ... eₚ_{ᵥ₋₁}] |
| | where column i of W, eᵢ, is has an element 1 on the row corresponding to the |
| | port pᵢ on which layer i is to be transmitted, and element 0 in all other rows, |
| | pᵢ < pᵢ₊₁, |
| | $N = {\sum }_{p = 0}^{7} δ ( p ) {2}^{p} , where δ ( p ) = 1 if a layer is to be transmitted on port p$ |
| | $and δ ( p ) = 0 otherwise , and Δ ( z ) = {\sum }_{k = 1}^{z} C ( 8 , k ) for x \geq 1 , where C ( x , y )$ |
| | is defined by Table 5.2.2.2.5-4 of 38.214. TPMI indices 0 to Δ(v) − 1 are |
| | mapped to values of N, first by increasing values of the number of transmitted |
| | layers, and then by increasing values of N for a given number of layers. |

Certain embodiments may provide one or more of the following technical advantage(s). The codebook size can be adapted based on the number of layers to reduce the DCI overhead. The reduced codebook size can also reduce network scheduling complexity because fewer precoders need to be considered for a given maximum rank.

Now, some example embodiments will be described in more detail.

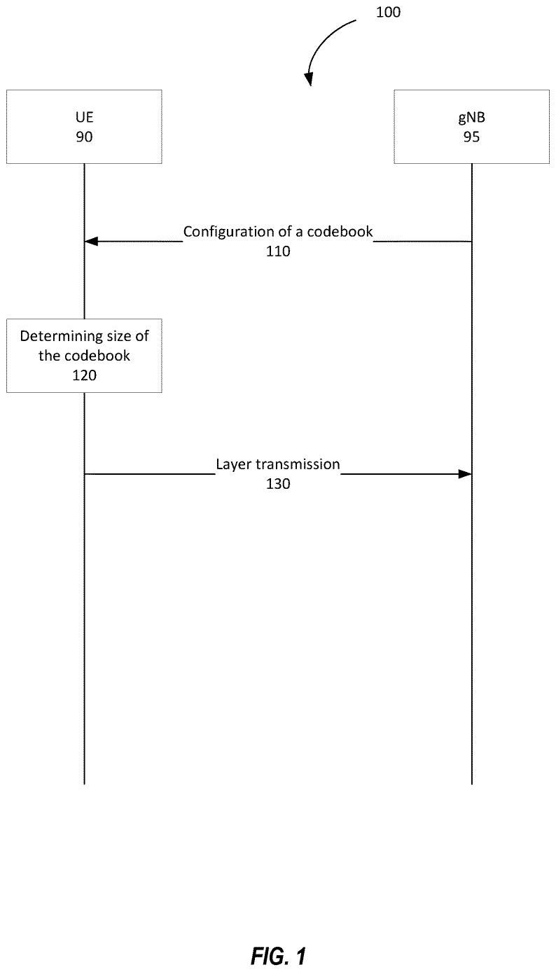

For example, FIG. 1 illustrates an example of a method 100 for a UE 90 to adapt a codebook, for transmissions with a gNB 95. In step 110, the UE receives a configuration of a codebook, from the gNB. Or in other words, the UE can receive from the network node (or gNB) signalling that configures the UE with precoders in the codebook to be used for transmission. In step 120, the UE determines the codebook size according to a maximum number of layers to be transmitted by the UE using the codebook, with a number of antenna ports that is at least two and is not more than 8. Further, the UE can form a first list of precoder indices, map a second list of precoder indices to the first list, wherein e.g., the lowest index to the highest index of the second list is mapped to the first list by first by increasing values of L in the first list, L being the number of layers, and then e.g., by increasing values of the first list corresponding to a given value of N. The parameter N is given in Table 6, for example. In one embodiment, each index of the first list is determined by multiplying each port number of a set of port numbers by a weighting factor corresponding to the port number to form a weighted port number, and summing the weighted port numbers.

There are L non-zero weighted port numbers, and the index of the first list corresponds to a transmission by the UE of the L layers.

This example can be described by the following example captured in the table 7 below, where the TPMI index corresponds to the second list, and the first index value in the table corresponds to the first list of precoder indices or the values of the parameter N. The TPMI index is the quantity identified by control signaling and that selects the precoder. The rank is the number of layers in the precoder. Because a non-coherent codebook is used, the rank is also the number of active antenna ports in the precoder.

TABLE 7

| Active antenna ports, | | | |
|---|---|---|---|
| according to [p7, p6, p5, | | | |
| p4, p3, p2, p1, p0], where | | | |
| ‘1’ indicates an active port | First index value | Rank | TPMI Index |
| ‘00000001’ | 1 | 1 | 0 |
| ‘00000010’ | 2 | 1 | 1 |
| ‘00000100’ | 4 | 1 | 2 |
| ‘00001000’ | 8 | 1 | 3 |
| ‘00010000’ | 16 | 1 | 4 |
| ‘00100000’ | 32 | 1 | 5 |
| ‘01000000’ | 64 | 1 | 6 |
| ‘10000000’ | 128 | 1 | 7 |
| ‘00000011’ | 3 | 2 | 8 |
| ‘00000101’ | 5 | 2 | 9 |
| ‘00000110’ | 6 | 2 | 10 |
| ‘00001001’ | 9 | 2 | 11 |
| ‘00001010’ | 10 | 2 | 12 |
| ‘00001100’ | 12 | 2 | 13 |
| ‘00010001’ | 17 | 2 | 14 |
| ‘00010010’ | 18 | 2 | 15 |
| ‘00010100’ | 20 | 2 | 16 |
| ‘00011000’ | 24 | 2 | 17 |
| ‘00100001’ | 33 | 2 | 18 |
| ‘00100010’ | 34 | 2 | 19 |
| ‘00100100’ | 36 | 2 | 20 |
| ‘00101000’ | 40 | 2 | 21 |
| ‘00110000’ | 48 | 2 | 22 |
| ‘01000001’ | 65 | 2 | 23 |
| ‘01000010’ | 66 | 2 | 24 |
| ‘01000100’ | 68 | 2 | 25 |
| ‘01001000’ | 72 | 2 | 26 |
| ‘01010000’ | 80 | 2 | 27 |
| ‘01100000’ | 96 | 2 | 28 |
| ‘10000001’ | 129 | 2 | 29 |
| ‘10000010’ | 130 | 2 | 30 |
| ‘10000100’ | 132 | 2 | 31 |
| ‘10001000’ | 136 | 2 | 32 |
| ‘10010000’ | 144 | 2 | 33 |
| ‘10100000’ | 160 | 2 | 34 |
| ‘11000000’ | 192 | 2 | 35 |
| ‘00000111’ | 7 | 3 | 36 |
| ‘00001011’ | 11 | 3 | 37 |
| ‘00001101’ | 13 | 3 | 38 |
| ‘00001110’ | 14 | 3 | 39 |
| ‘00010011’ | 19 | 3 | 40 |
| ‘00010101’ | 21 | 3 | 41 |
| ‘00010110’ | 22 | 3 | 42 |
| ‘00011001’ | 25 | 3 | 43 |
| ‘00011010’ | 26 | 3 | 44 |
| ‘00011100’ | 28 | 3 | 45 |
| ‘00100011’ | 35 | 3 | 46 |
| ‘00100101’ | 37 | 3 | 47 |
| ‘00100110’ | 38 | 3 | 48 |
| ‘00101001’ | 41 | 3 | 49 |
| ‘00101010’ | 42 | 3 | 50 |
| ‘00101100’ | 44 | 3 | 51 |
| ‘00110001’ | 49 | 3 | 52 |
| ‘00110010’ | 50 | 3 | 53 |
| ‘00110100’ | 52 | 3 | 54 |
| ‘00111000’ | 56 | 3 | 55 |
| ‘01000011’ | 67 | 3 | 56 |
| ‘01000101’ | 69 | 3 | 57 |
| ‘01000110’ | 70 | 3 | 58 |
| ‘01001001’ | 73 | 3 | 59 |
| ‘01001010’ | 74 | 3 | 60 |
| ‘01001100’ | 76 | 3 | 61 |
| ‘01010001’ | 81 | 3 | 62 |
| ‘01010010’ | 82 | 3 | 63 |
| ‘01010100’ | 84 | 3 | 64 |
| ‘01011000’ | 88 | 3 | 65 |
| ‘01100001’ | 97 | 3 | 66 |
| ‘01100010’ | 98 | 3 | 67 |
| ‘01100100’ | 100 | 3 | 68 |
| ‘01101000’ | 104 | 3 | 69 |
| ‘01110000’ | 112 | 3 | 70 |
| ‘10000011’ | 131 | 3 | 71 |
| ‘10000101’ | 133 | 3 | 72 |
| ‘10000110’ | 134 | 3 | 73 |
| ‘10001001’ | 137 | 3 | 74 |
| ‘10001010’ | 138 | 3 | 75 |
| ‘10001100’ | 140 | 3 | 76 |
| ‘10010001’ | 145 | 3 | 77 |
| ‘10010010’ | 146 | 3 | 78 |
| ‘10010100’ | 148 | 3 | 79 |
| ‘10011000’ | 152 | 3 | 80 |
| ‘10100001’ | 161 | 3 | 81 |
| ‘10100010’ | 162 | 3 | 82 |
| ‘10100100’ | 164 | 3 | 83 |
| ‘10101000’ | 168 | 3 | 84 |
| ‘10110000’ | 176 | 3 | 85 |
| ‘11000001’ | 193 | 3 | 86 |
| ‘11000010’ | 194 | 3 | 87 |
| ‘11000100’ | 196 | 3 | 88 |
| ‘11001000’ | 200 | 3 | 89 |
| ‘11010000’ | 208 | 3 | 90 |
| ‘11100000’ | 224 | 3 | 91 |
| ‘00001111’ | 15 | 4 | 92 |
| ‘00010111’ | 23 | 4 | 93 |
| ‘00011011’ | 27 | 4 | 94 |
| ‘00011101’ | 29 | 4 | 95 |
| ‘00011110’ | 30 | 4 | 96 |
| ‘00100111’ | 39 | 4 | 97 |
| ‘00101011’ | 43 | 4 | 98 |
| ‘00101101’ | 45 | 4 | 99 |
| ‘00101110’ | 46 | 4 | 100 |
| ‘00110011’ | 51 | 4 | 101 |
| ‘00110101’ | 53 | 4 | 102 |
| ‘00110110’ | 54 | 4 | 103 |
| ‘00111001’ | 57 | 4 | 104 |
| ‘00111010’ | 58 | 4 | 105 |
| ‘00111100’ | 60 | 4 | 106 |
| ‘01000111’ | 71 | 4 | 107 |
| ‘01001011’ | 75 | 4 | 108 |
| ‘01001101’ | 77 | 4 | 109 |
| ‘01001110’ | 78 | 4 | 110 |
| ‘01010011’ | 83 | 4 | 111 |
| ‘01010101’ | 85 | 4 | 112 |
| ‘01010110’ | 86 | 4 | 113 |
| ‘01011001’ | 89 | 4 | 114 |
| ‘01011010’ | 90 | 4 | 115 |
| ‘01011100’ | 92 | 4 | 116 |
| ‘01100011’ | 99 | 4 | 117 |
| ‘01100101’ | 101 | 4 | 118 |
| ‘01100110’ | 102 | 4 | 119 |
| ‘01101001’ | 105 | 4 | 120 |
| ‘01101010’ | 106 | 4 | 121 |
| ‘01101100’ | 108 | 4 | 122 |
| ‘01110001’ | 113 | 4 | 123 |
| ‘01110010’ | 114 | 4 | 124 |
| ‘01110100’ | 116 | 4 | 125 |
| ‘01111000’ | 120 | 4 | 126 |
| ‘10000111’ | 135 | 4 | 127 |
| ‘10001011’ | 139 | 4 | 128 |
| ‘10001101’ | 141 | 4 | 129 |
| ‘10001110’ | 142 | 4 | 130 |
| ‘10010011’ | 147 | 4 | 131 |
| ‘10010101’ | 149 | 4 | 132 |
| ‘10010110’ | 150 | 4 | 133 |
| ‘10011001’ | 153 | 4 | 134 |
| ‘10011010’ | 154 | 4 | 135 |
| ‘10011100’ | 156 | 4 | 136 |
| ‘10100011’ | 163 | 4 | 137 |
| ‘10100101’ | 165 | 4 | 138 |
| ‘10100110’ | 166 | 4 | 139 |
| ‘10101001’ | 169 | 4 | 140 |
| ‘10101010’ | 170 | 4 | 141 |
| ‘10101100’ | 172 | 4 | 142 |
| ‘10110001’ | 177 | 4 | 143 |
| ‘10110010’ | 178 | 4 | 144 |
| ‘10110100’ | 180 | 4 | 145 |
| ‘10111000’ | 184 | 4 | 146 |
| ‘11000011’ | 195 | 4 | 147 |
| ‘11000101’ | 197 | 4 | 148 |
| ‘11000110’ | 198 | 4 | 149 |
| ‘11001001’ | 201 | 4 | 150 |
| ‘11001010’ | 202 | 4 | 151 |
| ‘11001100’ | 204 | 4 | 152 |
| ‘11010001’ | 209 | 4 | 153 |
| ‘11010010’ | 210 | 4 | 154 |
| ‘11010100’ | 212 | 4 | 155 |
| ‘11011000’ | 216 | 4 | 156 |
| ‘11100001’ | 225 | 4 | 157 |
| ‘11100010’ | 226 | 4 | 158 |
| ‘11100100’ | 228 | 4 | 159 |
| ‘11101000’ | 232 | 4 | 160 |
| ‘11110000’ | 240 | 4 | 161 |
| ‘00011111’ | 31 | 5 | 162 |
| ‘00101111’ | 47 | 5 | 163 |
| ‘00110111’ | 55 | 5 | 164 |
| ‘00111011’ | 59 | 5 | 165 |
| ‘00111101’ | 61 | 5 | 166 |
| ‘00111110’ | 62 | 5 | 167 |
| ‘01001111’ | 79 | 5 | 168 |
| ‘01010111’ | 87 | 5 | 169 |
| ‘01011011’ | 91 | 5 | 170 |
| ‘01011101’ | 93 | 5 | 171 |
| ‘01011110’ | 94 | 5 | 172 |
| ‘01100111’ | 103 | 5 | 173 |
| ‘01101011’ | 107 | 5 | 174 |
| ‘01101101’ | 109 | 5 | 175 |
| ‘01101110’ | 110 | 5 | 176 |
| ‘01110011’ | 115 | 5 | 177 |
| ‘01110101’ | 117 | 5 | 178 |
| ‘01110110’ | 118 | 5 | 179 |
| ‘01111001’ | 121 | 5 | 180 |
| ‘01111010’ | 122 | 5 | 181 |
| ‘01111100’ | 124 | 5 | 182 |
| ‘10001111’ | 143 | 5 | 183 |
| ‘10010111’ | 151 | 5 | 184 |
| ‘10011011’ | 155 | 5 | 185 |
| ‘10011101’ | 157 | 5 | 186 |
| ‘10011110’ | 158 | 5 | 187 |
| ‘10100111’ | 167 | 5 | 188 |
| ‘10101011’ | 171 | 5 | 189 |
| ‘10101101’ | 173 | 5 | 190 |
| ‘10101110’ | 174 | 5 | 191 |
| ‘10110011’ | 179 | 5 | 192 |
| ‘10110101’ | 181 | 5 | 193 |
| ‘10110110’ | 182 | 5 | 194 |
| ‘10111001’ | 185 | 5 | 195 |
| ‘10111010’ | 186 | 5 | 196 |
| ‘10111100’ | 188 | 5 | 197 |
| ‘11000111’ | 199 | 5 | 198 |
| ‘11001011’ | 203 | 5 | 199 |
| ‘11001101’ | 205 | 5 | 200 |
| ‘11001110’ | 206 | 5 | 201 |
| ‘11010011’ | 211 | 5 | 202 |
| ‘11010101’ | 213 | 5 | 203 |
| ‘11010110’ | 214 | 5 | 204 |
| ‘11011001’ | 217 | 5 | 205 |
| ‘11011010’ | 218 | 5 | 206 |
| ‘11011100’ | 220 | 5 | 207 |
| ‘11100011’ | 227 | 5 | 208 |
| ‘11100101’ | 229 | 5 | 209 |
| ‘11100110’ | 230 | 5 | 210 |
| ‘11101001’ | 233 | 5 | 211 |
| ‘11101010’ | 234 | 5 | 212 |
| ‘11101100’ | 236 | 5 | 213 |
| ‘11110001’ | 241 | 5 | 214 |
| ‘11110010’ | 242 | 5 | 215 |
| ‘11110100’ | 244 | 5 | 216 |
| ‘11111000’ | 248 | 5 | 217 |
| ‘00111111’ | 63 | 6 | 218 |
| ‘01011111’ | 95 | 6 | 219 |
| ‘01101111’ | 111 | 6 | 220 |
| ‘01110111’ | 119 | 6 | 221 |
| ‘01111011’ | 123 | 6 | 222 |
| ‘01111101’ | 125 | 6 | 223 |
| ‘01111110’ | 126 | 6 | 224 |
| ‘10011111’ | 159 | 6 | 225 |
| ‘10101111’ | 175 | 6 | 226 |
| ‘10110111’ | 183 | 6 | 227 |
| ‘10111011’ | 187 | 6 | 228 |
| ‘10111101’ | 189 | 6 | 229 |
| ‘10111110’ | 190 | 6 | 230 |
| ‘11001111’ | 207 | 6 | 231 |
| ‘11010111’ | 215 | 6 | 232 |
| ‘11011011’ | 219 | 6 | 233 |
| ‘11011101’ | 221 | 6 | 234 |
| ‘11011110’ | 222 | 6 | 235 |
| ‘11100111’ | 231 | 6 | 236 |
| ‘11101011’ | 235 | 6 | 237 |
| ‘11101101’ | 237 | 6 | 238 |
| ‘11101110’ | 238 | 6 | 239 |
| ‘11110011’ | 243 | 6 | 240 |
| ‘11110101’ | 245 | 6 | 241 |
| ‘11110110’ | 246 | 6 | 242 |
| ‘11111001’ | 249 | 6 | 243 |
| ‘11111010’ | 250 | 6 | 244 |
| ‘11111100’ | 252 | 6 | 245 |
| ‘01111111’ | 127 | 7 | 246 |
| ‘10111111’ | 191 | 7 | 247 |
| ‘11011111’ | 223 | 7 | 248 |
| ‘11101111’ | 239 | 7 | 249 |
| ‘11110111’ | 247 | 7 | 250 |
| ‘11111011’ | 251 | 7 | 251 |
| ‘11111101’ | 253 | 7 | 252 |
| ‘11111110’ | 254 | 7 | 253 |
| ‘11111111’ | 255 | 8 | 254 |

As can be seen in Table 7, if we restrict to rank 1, the maximum codepoint index (e.g. TPMI index) is 7, requiring 3 bits TPMI bitfield, however, for the column with “First index value”, the maximum codepoint index is 128, requiring 7 bits TPMI field. Hence, DCI overhead reduction can be achieved with the TPMI mapping corresponding to the mapping as described in Table 7.

Another example is given below in Table 8, this time assuming 4 antenna ports:

TABLE 8

| | Active antenna | | |
|---|---|---|---|
| | ports, according to | | |
| | [p7, p6, p5, p4, p3, | | |
| | p2, p1, p0], where | | TPMI |
| First precoder | ‘1’ indicates an | | (Second precoder |
| index | active port | Rank | index) |
| 0 | 0000 | 0 (degenrated) | 0 |
| 1 | 0001 | 1 | 1 |
| 2 | 0010 | 1 | 2 |
| 3 | 0011 | 2 | 5 |
| 4 | 0100 | 1 | 3 |
| 5 | 0101 | 2 | 6 |
| 6 | 0110 | 2 | 7 |
| 7 | 0111 | 3 | 11 |
| 8 | 1000 | 1 | 4 |
| 9 | 1001 | 2 | 8 |
| 10 | 1010 | 2 | 9 |
| 11 | 1011 | 3 | 12 |
| 12 | 1100 | 2 | 10 |
| 13 | 1101 | 3 | 13 |
| 14 | 1110 | 3 | 14 |
| 15 | 1111 | 4 | 15 |

Note that, in these examples, the indices (corresponding to the first precoder indices or values of N) are generated as the decimal representation of the binary vector corresponding to the active ports, resulting in indices starting from 0 (which is a degenerative case with no active antenna ports). An offset could easily be added to the first and/or second index, for example such that TPMI index 0 corresponds to first index 1 (and not 0 as in the example above). The offset could also be made dependent on the rank (the variable z) if it is desirable to start the indexing for a certain rank on a specific number.

In some embodiments, the codebook size is determined according to

$$Δ ( z ) = {\sum }_{k = 1}^{z} C ( 8 , k )$$

for x≥1, where z is the maximum number of layers to be transmitted by the UE using the codebook and C(x,y) is defined by Table 5.2.2.2.5-4 of 3GPP TS 38.214 (see table below). For example, if the codebook is limited to rank 3, 92 TPMI values are needed, and so A (3)=92, and the maximum value of the TPMIs needed in the codebook table is 91. This allows a 7 TPMI field to be used instead of an 8 bitfield. Similarly if only rank 2 is needed, A (z)=36, a maximum TPI value of 35 is needed, and the TPMI field could be 6 bits.

TABLE 5.2.2.2.5-4
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

In some embodiments, the weighting factor is non-zero only if a layer is to be transmitted on the port with the port number. This is illustrated in the column labeled ‘Active antenna ports, according to [p7, p6, p5, p4, p3, p2, p1, p0], where ‘1’ indicates an active port’ in the table 8.

In some such embodiments, the non-zero weighting factor is 2P and p is the port number. This is also illustrated in the column labeled ‘Active antenna ports, according to [p7, p6, p5, p4, p3, p2, p1, p0], where ‘1’ indicates an active port’ in the table 8.

In step 130 of FIG. 1, the UE transmits a layer on an antenna port that corresponds to a value/index of the first list. For example, the UE transmits the layer using a precoder corresponding to the TPMI index mapped to the corresponding value (index) of N (e.g. the first list).

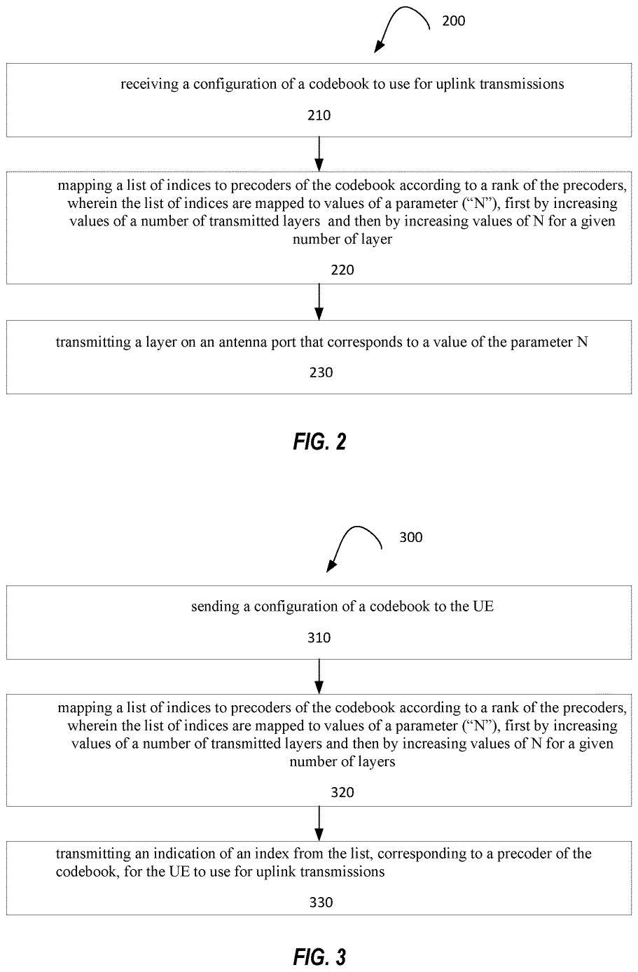

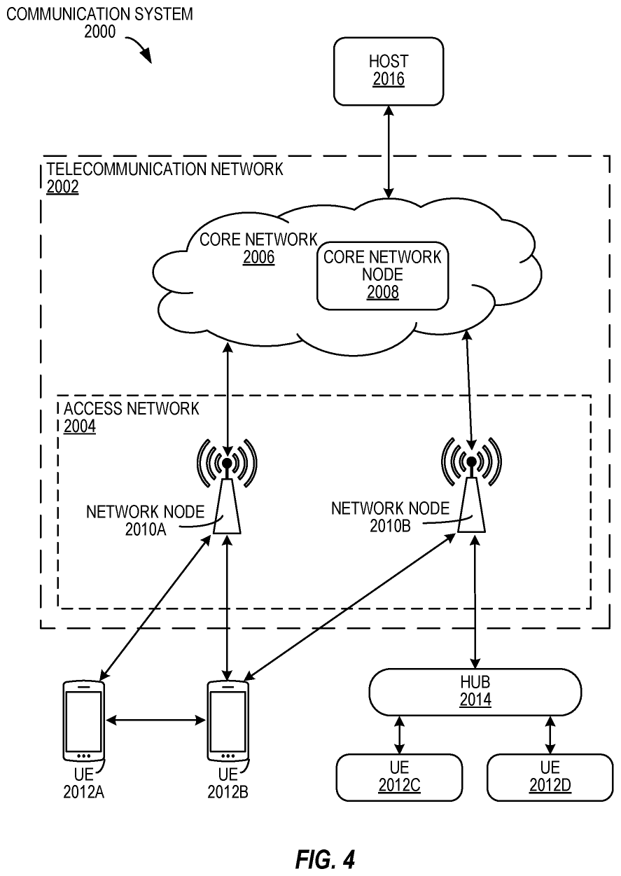

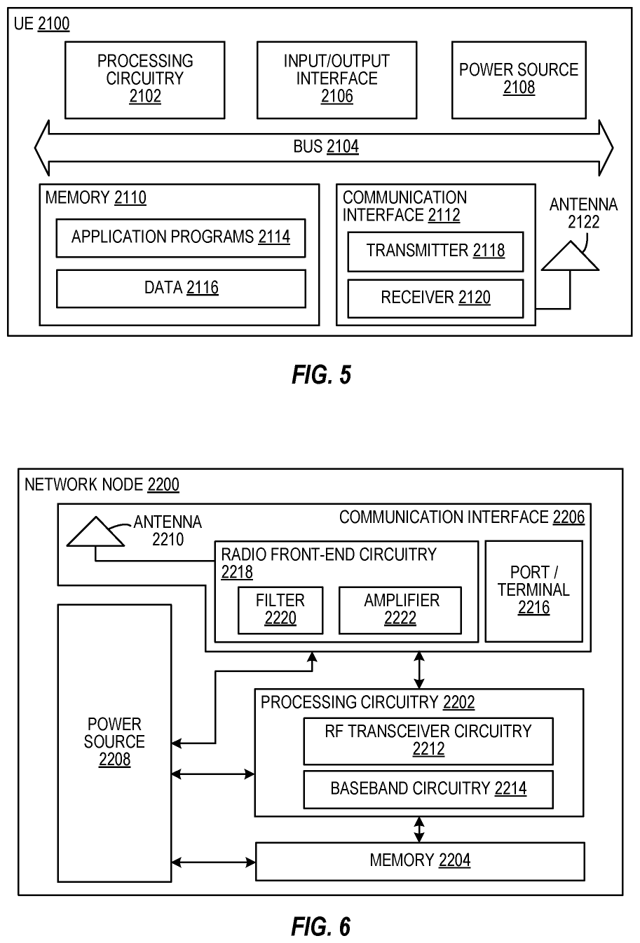

Now turning to FIG. 2, an exemplary flow chart of a method 200 implemented in a UE 90, such as UE 2012 of FIG. 4 or UE 2100 of FIG. 5, will be described. The method allows the UE to adapt the codebook size based on layers. Method 200 comprises:

Step 210: receiving a configuration of a codebook to use for uplink transmissions;

Step 220: mapping a list of indices to precoders of the codebook according to a rank of the precoders, wherein the list of indices are mapped to values of a parameter (“N”), first by increasing values of a number of transmitted layers and then by increasing values of N for a given number of layer;

Step 230: transmitting a layer on an antenna port that corresponds to a value of the parameter N.

In some examples, the codebook is for a number of antenna ports between 2 and 8. In some embodiments, the UE may determine a size of the codebook based on a maximum number of layers (z) to be transmitted by the UE. In some examples, the UE determines the size of the codebook by determining

$$Δ ( z ) = {\sum }_{k = 1}^{z} C ( 8 , k )$$

for x≥1, where z is the maximum number of layers to be transmitted by the UE using the codebook and C(x,y) is defined by Table 5.2.2.2.5-4 of 3GPP TS 38.214 and A (z) is the size of the codebook based on the maximum number of layers.

In some examples, the values of the parameter N are decimal representation of a binary vector corresponding to active ports. In some examples, each value of the parameter N is determined by multiplying each antenna port number of a set of port numbers by a weighting factor corresponding to the port number to form a weighted port number, and summing the weighted port numbers. In some examples, there are L non-zero weighted port numbers and the values of the parameter N correspond to a transmission by the UE of L layers. In some examples, the weighting factor is non-zero only if a layer is to be transmitted on a port corresponding to the port number.

In some examples, the non-zero weighting factor is 2P where p is the port number. In some examples an index of the list corresponds to a TPMI. In some examples, the values of N are comprised within a first list of precoder indices and the list of indices to precoders of the codebook corresponds to a second list of precoder indices. In some examples, an offset is applied to one or more of the list of indices and the values of the parameter N. In some examples the offset is dependent on a rank. In some examples the codebook is a non-coherent codebook.

FIG. 3 is a flow chart that illustrates the operation of a network node in accordance with at least some of the embodiments described herein. More specifically, FIG. 3 illustrates an exemplary method 300 for adapting a codebook size at the network node. The network node may be, for example, a Radio Access Network (RAN) node such as, e.g., a base station (e.g., a gNB 95), such as gNB 2200 of FIG. 6 or network node 2010 of FIG. 4, a RAN node that implements some of the functionality of a base station (e.g., a gNB-Distributed Unit (DU)). Method 300 comprises:

Step 310: sending a configuration of a codebook to the UE;

Step 320: mapping a list of indices to precoders of the codebook according to a rank of the precoders, wherein the list of indices are mapped to values of a parameter (“N”), first by increasing values of a number of transmitted layers and then by increasing values of N for a given number of layers; and

Step 330: transmitting an indication of an index from the list, corresponding to a precoder of the codebook, for the UE to use for uplink transmissions.

In some examples, the codebook is for a number of antenna ports between 2 and 8.

In some examples, the network node may determine a size of the codebook based on a maximum number of layers (z). In some examples, the network node determines the size of the codebook comprises by determining

$$Δ ( z ) = {\sum }_{k = 1}^{z} C ( 8 , k )$$

for x≥1, where z is the maximum number of layers to be transmitted by the UE using the codebook and C(x,y) is defined by Table 5.2.2.2.5-4 of 3GPP TS 38.214 and Δ(z) is the size of the codebook based on the maximum number of layers. In some examples, the values of the parameter N are decimal representation of a binary vector corresponding to active ports. In some examples, each value of the parameter Nis determined by multiplying each antenna port number of a set of port numbers by a weighting factor corresponding to the port number to form a weighted port number, and summing the weighted port numbers. In some examples, there are L non-zero weighted port numbers and the values of the parameter N correspond to a transmission by the UE of L layers. In some examples, the weighting factor is non-zero only if a layer is to be transmitted on a port corresponding to the port number.

In some examples, the non-zero weighting factor is 2^{p} where p is the port number. In some examples, an index of the list corresponds to a TPMI. In some examples, the values of N are comprised within a first list of precoder indices and the list of indices to precoders of the codebook corresponds to a second list of precoder indices. In some examples, the codebook is a non-coherent codebook.

As a note, while the method is for a network node, some of the steps may take place not at the network node, but remotely, e.g. on a user equipment. In some embodiments, all features described in connection with FIG. 2 are also applicable to methods for a network node, as depicted, but not limited to, FIG. 3.

Also, another embodiment of a method performed by a UE is described below. The method comprises: determining a codebook, wherein a precoding matrix W type A with 8 antenna groups for up to 8 layer transmission uses eight antenna ports, wherein up to 8 layers are supported with transform precoding disable and the precoding matrix W is given by

$$W = 1 / \sqrt{v} [ {e}_{{p}_{0}} … {e}_{{p}_{v - 1}} ]$$

where column i of W, eᵢ, is has an element 1 on the row corresponding to the port pᵢ on which layer i is to be transmitted, and element 0 in all other rows,

$${p}_{i} < {p}_{i + 1} ,$$

$$N = {\sum }_{p = 0}^{7} δ ( p ) {2}^{p} ,$$

where δ(p)=1 if a layer is to be transmitted on port p and δ(p)=0 otherwise, and

$$Δ ( z ) = {\sum }_{k = 1}^{z} C ( 8 , k )$$

$$for x \geq 1 ,$$

where C(x,y) is defined by Table 5.2.2.2.5-4 of 38.214. TPMI indices 0 to Δ(v)−1 are mapped to values of N, first by increasing values of the number of transmitted layers, and then by increasing values of N for a given number of layers.

The UE may further determine a size of the codebook, wherein the size is A (v), with v being the number of layers.

FIG. 4 shows an example of a communication system 2000 in accordance with some embodiments.

In the example, the communication system 2000 includes a telecommunication network 2002 that includes an access network 2004, such as a RAN, and a core network 2006, which includes one or more core network nodes 2008. The access network 2004 includes one or more access network nodes, such as network nodes 2010A and 2010B (one or more of which may be generally referred to as network nodes 2010), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 2002 includes one or more Open-RAN (ORAN) network nodes. An ORAN network node is a node in the telecommunication network 2002 that supports an ORAN specification (e.g., a specification published by the O-RAN Alliance, or any similar organization) and may operate alone or together with other nodes to implement one or more functionalities of any node in the telecommunication network 2002, including one or more network nodes 2010 and/or core network nodes 2008.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 2010 facilitate direct or indirect connection of UE, such as by connecting UEs 2012A, 2012B, 2012C, and 2012D (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), etc.

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 4 enables connectivity between the UEs, network nodes, and hosts. In that sense, the communication system 2000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, etc.

In some examples, the telecommunication network 2002 is a cellular network that implements 3GPP standardized features. Accordingly, the telecommunication network 2002 may support network slicing to provide different logical networks to different devices that are connected to the telecommunication network 2002. For example, the telecommunication network 2002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single- or multi-Radio Access Technology (RAT) or multi-standard mode. For example, a UE may operate with any one or combination of WiFi, NR, and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 2014 communicates with the access network 2004 to facilitate indirect communication between one or more UEs (e.g., UE 2012C and/or 2012D) and network nodes (e.g., network node 2010B). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a Virtual Reality (VR) headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular if one or more of the UEs are low energy IoT devices.

The hub 2014 may have a constant/persistent or intermittent connection to the network node 2010B. The hub 2014 may also allow for a different communication scheme and/or schedule between the hub 2014 and UEs (e.g., UE 2012C and/or 2012D), and between the hub 2014 and the core network 2006. In other examples, the hub 2014 is connected to the core network 2006 and/or one or more UEs via a wired connection. Moreover, the hub 2014 may be configured to connect to a Machine-to-Machine (M2M) service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010B. In other embodiments, the hub 2014 may be a non-dedicated hub—that is, a device which is capable of operating to route communications between the UEs and the network node 2010B, but which is additionally capable of operating as a communication start and/or end point for certain data channels.

FIG. 5 shows a UE 2100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, wireless endpoint, mobile station, tablet, laptop, etc. Other examples include any UE identified by the 3GPP, including a Narrowband Internet of Things (NB-IOT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

The UE 2100 includes processing circuitry 2102 that is operatively coupled via a bus 2104 to an input/output interface 2106, a power source 2108, memory 2110, a communication interface 2112, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 2102 may include multiple Central Processing Units (CPUs). Further, the processing circuitry 2102 is configured to perform any of the steps of method 200 of FIG. 2.

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging of the power source 2108. Power circuitry may perform any formatting, converting, or other modification to the power from the power source 2108 to make the power suitable for the respective components of the UE 2100 to which power is supplied.

The memory 2110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 2110 may allow the UE 2100 to access instructions, application programs, and the like stored on transitory or non-transitory memory media, to off-load data, or to upload data. An article of manufacture, such as one utilizing a communication system, may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., the antenna 2122) and may share circuit components, software, or firmware, or alternatively be implemented separately.

In the illustrated embodiment, communication functions of the communication interface 2112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 2112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 6 shows a network node 2200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, NBs, evolved NBs (eNBs), NR NBs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes processing circuitry 2202, memory 2204, a communication interface 2206, and a power source 2208. The network node 2200 may be composed of multiple physically separate components (e.g., a NodeB (NB) component and an RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple NBs. In such a scenario, each unique NB and RNC pair may in some instances be considered a single separate network node. In some embodiments, the network node 2200 may be configured to support multiple RATs. In such embodiments, some components may be duplicated (e.g., separate memory 2204 for different RATs) and some components may be reused (e.g., a same antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 2200.

The processing circuitry 2202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 2200 components, such as the memory 2204, to provide network node 2200 functionality. Further, the processing circuitry 2202 may be configured to perform any of the steps of method 300 of FIG. 3.

In some embodiments, the processing circuitry 2202 includes a System on a Chip (SOC). In some embodiments, the processing circuitry 2202 includes one or more of Radio Frequency (RF) transceiver circuitry 2212 and baseband processing circuitry 2214. In some embodiments, the RF transceiver circuitry 2212 and the baseband processing circuitry 2214 may be on separate chips (or sets of chips), boards, or units, such as radio units and digital units. In alternative embodiments, part or all of the RF transceiver circuitry 2212 and the baseband processing circuitry 2214 may be on the same chip or set of chips, boards, or units.

The memory 2204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and the memory 2204 are integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. The radio front-end circuitry 2218 comprises filters 2220 and amplifiers 2222. The radio front-end circuitry 2218 may be connected to the antenna 2210 and the processing circuitry 2202. The radio front-end circuitry 2218 may be configured to condition signals communicated between the antenna 2210 and the processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of the filters 2220 and/or the amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface 2206 may comprise different components and/or different combinations of components.

In certain alternative embodiments, the network node 2200 does not include separate radio front-end circuitry 2218; instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes the one or more ports or terminals 2216, the radio front-end circuitry 2218, and the RF transceiver circuitry 2212 as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, the communication interface 2206, and/or the processing circuitry 2202 may be configured to perform any receiving operations and/or certain obtaining operations described herein as being performed by the network node 2200. Any information, data, and/or signals may be received from a UE, another network node, and/or any other network equipment. Similarly, the antenna 2210, the communication interface 2206, and/or the processing circuitry 2202 may be configured to perform any transmitting operations described herein as being performed by the network node 2200. Any information, data, and/or signals may be transmitted to a UE, another network node, and/or any other network equipment.

The power source 2208 provides power to the various components of the network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid or an electricity outlet) via input circuitry or an interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 6 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

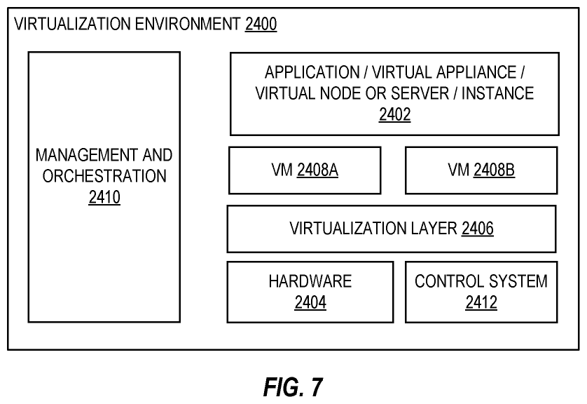

FIG. 7 is a block diagram illustrating a virtualization environment 2400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2400 includes components defined by the O-RAN Alliance, such as an O-Cloud environment orchestrated by a Service Management and Orchestration Framework via an O-2 interface.

Applications 2402 (which may alternatively be called software instances, virtual appliances, network functions, virtual nodes, virtual network functions, etc.) are run in the virtualization environment 2400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or VM Monitors (VMMs)), provide VMs 2408A and 2408B (one or more of which may be generally referred to as VMs 2408), and/or perform any of the functions, features, and/or benefits described in relation with some embodiments described herein. The virtualization layer 2406 may present a virtual operating platform that appears like networking hardware to the VMs 2408.

The VMs 2408 comprise virtual processing, virtual memory, virtual networking, or interface and virtual storage, and may be run by a corresponding virtualization layer 2406. Different embodiments of the instance of a virtual appliance 2402 may be implemented on one or more of the VMs 2408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2408 may be a software implementation of a physical machine that runs programs as if they were executing on a physical, non-virtualized machine. Each of the VMs 2408, and that part of the hardware 2404 that executes that VM, be it hardware dedicated to that VM and/or hardware shared by that VM with others of the VMs 2408, forms separate virtual network elements. Still in the context of NFV, a virtual network function is responsible for handling specific network functions that run in one or more VMs 2408 on top of the hardware 2404 and corresponds to the application 2402.

The hardware 2404 may be implemented in a standalone network node with generic or specific components. The hardware 2404 may implement some functions via virtualization. Alternatively, the hardware 2404 may be part of a larger cluster of hardware (e.g., such as in a data center or CPE) where many hardware nodes work together and are managed via management and orchestration 2410, which, among others, oversees lifecycle management of the applications 2402. In some embodiments, the hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 2412 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a User Equipment (UE) for uplink communications, the method comprising:
receiving a configuration of a codebook to use for uplink transmissions;
mapping a list of indices to precoders of the codebook according to a rank of the precoders, wherein the list of indices are mapped to values of a parameter (“N”), first by increasing values of a number of transmitted layers and then by increasing values of N for a given number of layers, wherein each value of the parameter N is determined by multiplying a weighting factor corresponding to the port number to form a weighted port number, and summing the weighted port numbers; and
transmitting a layer on an antenna port that corresponds to a value of the parameter N.

2. The method of claim 1, wherein the codebook is for a number of antenna ports between 2 and 8.

3. The method of claim 1, further comprising determining a size of the codebook based on a maximum number of layers (z) to be transmitted by the UE.

4. The method of claim 3, wherein determining the size of the codebook comprises determining
$$Δ ( z ) = {\sum }_{k = 1}^{z} C ( 8 , k )$$
for x≥1, where z is the maximum number of layers to be transmitted by the UE using the codebook and C(x,y) is defined by Table 5.2.2.2.5-4 of 3GPP TS 38.214 and Δ(z) is the size of the codebook based on the maximum number of layers.

5. The method of claim 1, wherein the values of the parameter N are decimal representation of a binary vector corresponding to active ports.

6. (canceled)

7. The method of claim 1, wherein there are L non-zero weighted port numbers and the values of the parameter N correspond to a transmission by the UE of L layers.

8. The method of claim 1, wherein the weighting factor is non-zero only if a layer is to be transmitted on a port corresponding to the port number.

9. The method of claim 8, wherein the non-zero weighting factor is 2P where p is the port number.

10. The method of claim 1, wherein an index of the list corresponds to a TPMI.

11. The method of claim 1, wherein the values of N are comprised within a first list of precoder indices and the list of indices to precoders of the codebook corresponds to a second list of precoder indices.

12. The method of claim 1, wherein an offset is applied to one or more of the list of indices and the values of the parameter N.

13. The method of claim 12, wherein the offset is dependent on a rank.

14. (canceled)

15. A method in a network node, in communications with a User Equipment (UE), the method comprising:
sending a configuration of a codebook to the UE;
mapping a list of indices to precoders of the codebook according to a rank of the precoders, wherein the list of indices are mapped to values of a parameter (“N”), first by increasing values of a number of transmitted layers and then by increasing values of N for a given number of layers, wherein each value of the parameter N is determined by multiplying a weighting factor corresponding to the port number to form a weighted port number, and summing the weighted port numbers; and
transmitting an indication of an index from the list, corresponding to a precoder of the codebook, for the UE to use for uplink transmissions.

16. (canceled)

17. (canceled)

18. The method of claim 15, wherein determining a size of the codebook comprises determining
$$Δ ( z ) = {\sum }_{k = 1}^{z} C ( 8 , k )$$
for x≥1, where z is the maximum number of layers to be transmitted by the UE using the codebook and C(x,y) is defined by Table 5.2.2.2.5-4 of 3GPP TS 38.214 and Δ(z) is the size of the codebook based on the maximum number of layers.

19. (canceled)

20. (canceled)

21. The method of claim 15, wherein there are L non-zero weighted port numbers and the values of the parameter N correspond to a transmission by the UE of L layers.

22. The method of claim 15, wherein the weighting factor is non-zero only if a layer is to be transmitted on a port corresponding to the port number.

23. The method of claim 22, wherein the non-zero weighting factor is 2P where p is the port number.

24. The method of claim 15, wherein an index of the list corresponds to a TPMI.

25. The method of claim 15, wherein the values of N are comprised within a first list of precoder indices and the list of indices to precoders of the codebook corresponds to a second list of precoder indices.

26. (canceled)

27. A User Equipment (UE) comprising processing circuitry and network interface, the processing circuitry configured to: receive a configuration of a codebook to use for uplink transmissions;
map a list of indices to precoders of the codebook according to a rank of the precoders, wherein the list of indices are mapped to values of a parameter (“N”), first by increasing values of a number of transmitted layers and then by increasing values of N for a given number of layers, wherein each value of the parameter N is determined by multiplying a weighting factor corresponding to the port number to form a weighted port number, and summing the weighted port numbers; and
transmit a layer on an antenna port that corresponds to a value of the parameter N.

28. (canceled)

29. (canceled)

30. (canceled)

31. (canceled)
